(19) United States
(12) Patent Application Publication
(10) Pub. No.: US 2026/0194680 A1
(43) Pub. Date: Jul. 9, 2026

(54) MULTI-PARAMETER MIMO AEROBORNE TIME-FREQUENCY ELECTROMAGNETIC DETECTION SYSTEM AND METHOD

(71) Applicant: AEROSPACE INFORMATION RESEARCH INSTITUTE, CHINESE ACADEMY OF SCIENCES, Beijing (CN)

(72) Inventors: Guangyou FANG, Beijing (CN); Lihua LIU, Beijing (CN); Jiankai LI, Beijing (CN); Jiangjie HUANG, Beijing (CN); Ling HUANG, Beijing (CN); Xiaojun LIU, Beijing (CN)

(73) Assignee: AEROSPACE INFORMATION RESEARCH INSTITUTE, CHINESE ACADEMY OF SCIENCES, Beijing (CN)

(21) Appl. No.: 19/440,355

(22) Filed: Jan. 5, 2026

(30) Foreign Application Priority Data
Jan. 9, 2025 (CN) 202510031548.0

(51) Int. Cl. G01V 3/16; G01V 3/08

(52) U.S. Cl. CPC G01V 3/16; G01V 3/083; G01V 2003/084

(57) ABSTRACT

A multi-parameter MIMO aeroborne time-frequency electromagnetic detection system and method is provided. The system includes: a flight platform; a transmitting subsystem configured to inject a first current pulse into a transmitting coil through a first current transmitter and inject a second current pulse into a bucking coil through a second current transmitter to realize excitation of a primary electromagnetic field and a bucking electromagnetic field; a receiving subsystem configured to sample the first and the second current pulses and acquire the secondary electromagnetic field response, to obtain electrical property information of underground media; and a measurement and control subsystem configured to send a control instruction to the transmitting subsystem and the receiving subsystem according to a sampling result and at least one set detection parameter, monitor a working status of the system, and adjust the first current pulse and the second current pulse in real time.

### CROSS-REFERENCE TO RELATED APPLICATION(S)

This application claims the benefit of Chinese Patent Application No. 202510031548.0 filed on Jan. 9, 2025, the whole disclosure of which is incorporated herein by reference.

### TECHNICAL FIELD

The present disclosure relates to a field of underground medium detection technology, in particular to a multi-parameter MIMO aeroborne time-frequency electromagnetic detection system and method based on a flight platform and electromagnetic detection technology, aiming to obtain electrical property information of valuable or new medium materials at different underground depths.

### BACKGROUND

Aeroborne Electromagnetic Method (AEM) is an electromagnetic detection technology based on an aeroborne flight platform, which may use the flight platform to place an entire loop source transceiver device in the air for electromagnetic signal observation, and has advantages such as flexibility, large detection range, low cost, and high efficiency. Therefore, the AEM is widely used in the detection of various resources such as underground mineral resources, oil and gas resources, and water resources, as well as the detection of various underground artificial/non-artificial structures and other targets.

In the process of realizing the concept of the present disclosure, the inventors found that the aeroborne detection system in the related art has a shallow detection blind zone, and it is difficult to realize airborne electric field measurement and synchronous observation of multi-component electromagnetic signals, resulting in limitations in the detection accuracy and range of the target detection region.

### SUMMARY

In view of this, the present disclosure provides a multi-parameter MIMO aeroborne time-frequency electromagnetic detection system and method.

An aspect of the present disclosure provides a multi-parameter MIMO aeroborne time-frequency electromagnetic detection system, including a flight platform, a transmitting subsystem, a receiving subsystem, and a measurement and control subsystem, where the transmitting subsystem and the receiving subsystem are hoisted under the flight platform; the transmitting subsystem includes a first current transmitter, a second current transmitter, a transmitting coil, and a bucking coil, the transmitting subsystem is configured to inject a first current pulse into the transmitting coil through the first current transmitter to realize an excitation of a primary electromagnetic field, and to inject a second current pulse into the bucking coil through the second current transmitter to realize an excitation of a bucking electromagnetic field, and the primary electromagnetic field acts on underground media at different depths of a target detection region to generate a secondary electromagnetic field response; the receiving subsystem is configured to sample the first current pulse and the second current pulse and acquire the secondary electromagnetic field response, so as to transmit the sampled and acquired data to the measurement and control subsystem for data processing to obtain electrical property information of the underground media in the target detection region; and the measurement and control subsystem is configured to send a control instruction to the transmitting subsystem and the receiving subsystem according to a sampling result and at least one set detection parameter, and monitor a working status of the detection system, such that during a detection process, the measurement and control subsystem, by adjusting the first current pulse and the second current pulse in real time, enable the bucking electromagnetic field to offset a primary electromagnetic field signal entrained in the secondary electromagnetic field response, realizing adaptive compensation.

According to embodiments of the present disclosure, by changing at least one set parameter of the first current pulse and/or the second current pulse, the transmitting coil excites the primary electromagnetic field suitable for deep detection and shallow detection according to a set timing sequence, and the bucking coil synchronously excites a bucking magnetic field to offset primary electromagnetic field interference acting on the receiving subsystem; and the at least one set parameter includes a frequency, an amplitude, a width, a waveform, a flow direction, and a timing sequence of each current pulse.

According to embodiments of the present disclosure, the receiving subsystem includes a magnetic field sensor, an electric field sensor, and an electromagnetic data receiver, and the secondary electromagnetic field response includes a magnetic field signal and an electric field signal, where the magnetic field sensor is configured to receive a three-component magnetic field signal, and the electric field sensor is configured to receive a horizontal-component electric field signal.

According to embodiments of the present disclosure, both the transmitting coil and the bucking coil are configured in an annular shape and arranged concentrically on a same plane, the bucking coil is smaller than the transmitting coil, and the magnetic field sensor is disposed at a central position of the bucking coil; by acquiring the primary electromagnetic field interference at the magnetic field sensor in real time, the second current pulse is adjusted such that the bucking coil excites the bucking electromagnetic field to offset the primary electromagnetic field interference.

According to embodiments of the present disclosure, the electric field sensor is a horizontal-component capacitive electric field sensor, including: an x-component electric field sensor used for measuring an x-component electric field signal parallel to a survey line direction of the detection system; and a y-component electric field sensor used for measuring a y-component electric field signal perpendicular to the survey line direction of the detection system.

According to embodiments of the present disclosure, the magnetic field sensor is a three-component coil magnetic field sensor, including: an x-component magnetic field sensor configured in a circular shape, with a normal direction of a circular plane pointing to an x-direction in a geographic Cartesian coordinate system, for measuring an x-component magnetic field in the magnetic field signal; a y-component magnetic field sensor configured in a circular shape, with a normal direction of a circular plane pointing to a y-direction in the geographic Cartesian coordinate system, for measuring a y-component magnetic field in the magnetic field signal; and a z-component magnetic field sensor configured in a circular shape, with a normal direction of a circular plane pointing to a z-direction in the geographic Cartesian coordinate system, for measuring a z-component magnetic field in the magnetic field signal, where the x-component magnetic field sensor, the y-component magnetic field sensor, and the z-component magnetic field sensor are nested and fixedly connected to each other through a connecting device and then placed in a spherical protective cover.

According to embodiments of the present disclosure, the electromagnetic data receiver includes a signal conditioning module, a signal acquisition module, a master control module, and a data transmission module, where the signal conditioning module includes a first signal conditioning module for filtering and amplifying the received magnetic field signal, and a second signal conditioning module for filtering and amplifying the received electric field signal; the signal acquisition module is configured to perform real-time data sampling on the transmitting coil, the bucking coil, and the signal conditioning module, respectively; and the master control module is configured to receive a real-time data sampling result and transmit the real-time data sampling result to the measurement and control subsystem, such that the measurement and control subsystem adjusts the first current pulse and the second current pulse in real time according to the real-time data sampling result.

According to embodiments of the present disclosure, the first current transmitter includes a first driving circuit, a first waveform controller, a first power inverter circuit, a first constant-voltage double-clamp circuit, and a first current detection circuit; the first power inverter circuit is configured to generate the first current pulse with the at least one set parameter under an action of the first driving circuit, the first waveform controller, and the first constant-voltage double-clamp circuit unit, and inject the first current pulse into the transmitting coil; and the second current transmitter includes a second driving circuit, a second waveform controller, a second power inverter circuit, a second constant-voltage double-clamp circuit, and a second current detection circuit, where the second power inverter circuit unit is configured to generate the second current pulse with the at least one set parameter under an action of the second driving circuit, the second waveform controller, and the second constant-voltage double-clamp circuit, and inject the second current pulse into the bucking coil; the first current detection circuit and the second current detection circuit are used to respectively detect parameters of a first current pulse signal and a second current pulse signal in the transmitting coil and the bucking coil in real time; and a current transmission control unit is configured to control the first current transmitter and the second current transmitter to operate under an action of the control instruction issued by the measurement and control subsystem.

According to embodiments of the present disclosure, the electrical property information of the underground media in the target detection region is obtained by performing joint inversion of electric field and magnetic field data on the secondary electromagnetic field response data, and the joint inversion includes: setting an initial resistivity model, where the resistivity model is a resistivity-depth imaging resistivity model; respectively calculating an error between a magnetic field response of the initial resistivity model and an observed magnetic field response and an error between an electric field response of the initial resistivity model and an observed electric field response by using a forward model for the magnetic field response and the electric field response, so as to obtain a magnetic field response error and an electric field response error; constructing a Jacobian matrix for inversion of magnetic field data and inversion of electric field data by using the forward model and the resistivity model, and respectively calculating a model update amount for the inversion of magnetic field data inversion and a model update amount for the inversion of electric field data inversion by using the magnetic field response error and the electric field response error; adding the model update amounts to model parameters to obtain an updated resistivity model; and performing iterative updating until a fitting error of the forward-modeled electric field and magnetic field response data of the updated resistivity model is less than a set threshold.

Another aspect of the present disclosure provides a multi-parameter MIMO aeroborne time-frequency electromagnetic detection method, including: injecting a first current pulse into a transmitting coil to realize an excitation of a primary electromagnetic field, where the primary electromagnetic field acts on underground media at different depths of a target detection region to generate a secondary electromagnetic field response; injecting a second current pulse into a bucking coil to realize an excitation of a bucking electromagnetic field; acquiring the first current pulse, the second current pulse, and secondary electromagnetic field response data, and performing data processing; sending a control instruction according to a data processing result and at least one set detection parameter, and monitoring a working status of a detection system; adjusting the first current pulse and the second current pulse in real time to enable the bucking electromagnetic field to offset a primary electromagnetic field signal entrained in the secondary electromagnetic field response, realizing adaptive compensation; and performing joint inversion of electric field and magnetic field data according to the secondary electromagnetic field response data to obtain electrical property information of the underground media in the target detection region.

According to embodiments of the present disclosure, the transmitting subsystem injects a first current pulse into the transmitting coil through the first current transmitter to realize an excitation of a primary electromagnetic field, and injects a second current pulse into the bucking coil through the second current transmitter to realize an excitation of a bucking electromagnetic field, and the primary electromagnetic field acts on underground media at different depths of a target detection region to generate a secondary electromagnetic field response; the receiving subsystem samples the first current pulse and the second current pulse and acquires the secondary electromagnetic field response, so as to transmit the sampled and acquired data to the measurement and control subsystem for data processing to obtain electrical property information of the underground media in the target detection region; and the measurement and control subsystem sends a control instruction to the transmitting subsystem and the receiving subsystem according to a sampling result and at least one set detection parameter, and monitor a working status of the detection system, such that during a detection process, the measurement and control subsystem, by adjusting the first current pulse and the second current pulse in real time, enable the bucking electromagnetic field to offset a primary electromagnetic field signal entrained in the secondary electromagnetic field response, realizing adaptive compensation. The secondary electromagnetic field response is generated after the primary electromagnetic field acts on underground media at different depths of the target detection region, such that multi-component electromagnetic field data may be simultaneously acquired, and different depths of the target detection region are considered. At the same time, the measurement and control subsystem sends a control instruction to the transmitting subsystem and the receiving subsystem to adjust the first current pulse and the second current pulse in real time, such that the bucking electromagnetic field may offset the primary electromagnetic field signal entrained in the secondary electromagnetic field response, reducing primary field electromagnetic interference and obtaining relatively pure multi-component magnetic field data. This avoids the primary field compensation method in the related art where the transmitting coil and the bucking coil are directly connected in series, and realizes adaptive compensation, thereby making the electrical property information of the underground media in the target detection region obtained through analysis more accurate. Therefore, the technical problems in the related art, such as the existence of a shallow blind zone in electromagnetic detection of the target detection region and single electromagnetic response parameter, are effectively solved.

### BRIEF DESCRIPTION OF THE DRAWINGS

The above and other objectives, features and advantages of the present disclosure will be more apparent through the following description of embodiments of the present disclosure with reference to the accompanying drawings, wherein:

FIG. 1 shows a schematic diagram of a multi-parameter MIMO aeroborne time-frequency electromagnetic detection system according to an embodiment of the present disclosure;

FIG. 2 shows a structural schematic diagram of a flight platform, a transmitting subsystem, and a receiving subsystem according to an embodiment of the present disclosure;

FIG. 3 shows a schematic diagram of a principle of adaptive compensation performed by a multi-parameter MIMO aeroborne time-frequency electromagnetic detection system according to an embodiment of the present disclosure;

FIG. 4 shows a schematic circuit diagram of a multi-parameter MIMO aeroborne time-frequency electromagnetic detection system according to an embodiment of the present disclosure;

FIG. 5 shows a schematic waveform diagram of a received signal and a transmitted signal of a multi-parameter MIMO aeroborne time-frequency electromagnetic detection system according to an embodiment of the present disclosure;

FIG. 6 shows a schematic diagram of obtaining electrical property information of underground media in a target detection region through joint inversion according to an embodiment of the present disclosure; and

FIG. 7 schematically shows a flowchart of a multi-parameter MIMO aeroborne time-frequency electromagnetic detection method according to an embodiment of the present disclosure.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of the present disclosure. In the following detailed descriptions, for purposes of explanation, numerous specific details are set forth in order to provide a thorough understanding of embodiments of the present disclosure. It is obvious, however, that one or more embodiments may be implemented without these specific details. In addition, in the following descriptions, descriptions of well-known structures and technologies are omitted to avoid unnecessarily obscuring the concept of the present disclosure.

Terms used herein are for the purpose of describing embodiments only and are not intended to limit the present disclosure. Terms “comprising”, “including” and the like used herein specify a presence of the feature, step, operation and/or component, but do not preclude a presence or addition of one or more other features, steps, operations or components.

All terms (including technical and scientific terms) used herein have the meaning as commonly understood by those skilled in the art, unless otherwise defined. It should be noted that the terms used herein should be construed to have meanings consistent with the context of the present description and should not be construed in an idealized or overly rigid manner.

Where expressions like “at least one of A, B, and C, etc.” are used, they should generally be interpreted in accordance with the meaning of the expression as commonly understood by those skilled in the art (e.g., “a system having at least one of A, B and C” should include, but not be limited to, a system having A alone, having B alone, having C alone, having A and B, having A and C, having B and C, and/or having A, B, C, etc.).

In embodiments of the present disclosure, the collection, update, analysis, processing, usage, transmission, provision, disclosure, storage and other aspects of the involved data (e.g., including but not limited to surveying and mapping information, user personal information) all comply with the provisions of relevant laws and regulations, are used for legitimate purposes, and do not violate public order and good customs.

The basic principle of the Aeroborne Electromagnetic Method (AEM) is to use a single-turn or multi-turn ungrounded loop or a long grounded wire as a transmitting antenna to emit a primary pulse magnetic field to the underground; during the interval of the primary pulse magnetic field, a receiving coil or a grounded electrode is used to observe the secondary induced eddy current field caused in the underground medium. By measuring the change rule of the secondary field along with time, spatial distribution information at different depths is obtained. According to different instrument carrying platforms, the aeroborne electromagnetic method is mainly divided into two modes: full aeroborne and semi-aeroborne. The full aeroborne electromagnetic method is that: integrated electromagnetic field transmitting and receiving equipment is completely carried on a flight platform, an aerial transmitting loop source is used to excite a primary pulse magnetic field (referred to as the primary field), then an aerial electromagnetic field sensor is used for highly sensitively observing a secondary electromagnetic field response (referred to as the secondary field) generated by an underground abnormal electrical body, and the dielectric property of an underground target or object in the detection region is obtained by processing and inverting the received data.

However, in order to achieve a large detection depth, the related art adopts periodic large-current emission to achieve a large transmitting magnetic moment, thus it cannot take into account shallow detection, resulting in a shallow detection blind zone. At the same time, restricted by sensor technology, the related art may only observe a magnetic field signal in the air, making it difficult to measure an electric field in the air and to realize synchronous observation of electromagnetic signals of a plurality of parameters, thus leading to insufficient ability to identify an underground target detection region. In addition, while realizing large magnetic moment emission, in order to solve the unsaturation of received signals, the related art generally adopts a primary field compensation technology to compensate the strong primary field between transmission and reception to zero, so as to obtain a pure secondary field response signal, which provides high-quality data guarantee for subsequent electromagnetic data processing and target detection and identification. However, during actual flight, the bucking coil will undergo geometric deformation, resulting in incomplete compensation of the primary field, such that the residual primary field affects the detection effect.

In view of this, embodiments of the present disclosure provide a multi-parameter MIMO aeroborne time-frequency electromagnetic detection system, including a flight platform, a transmitting subsystem, a receiving subsystem, and a measurement and control subsystem, where the transmitting subsystem and the receiving subsystem are hoisted under the flight platform; the transmitting subsystem includes a first current transmitter, a second current transmitter, a transmitting coil, and a bucking coil, the transmitting subsystem is configured to inject a first current pulse into the transmitting coil through the first current transmitter to realize an excitation of a primary electromagnetic field, and to inject a second current pulse into the bucking coil through the second current transmitter to realize an excitation of a bucking electromagnetic field, and the primary electromagnetic field acts on underground media at different depths of a target detection region to generate a secondary electromagnetic field response; the receiving subsystem is configured to sample the first current pulse and the second current pulse and acquire the secondary electromagnetic field response, so as to transmit the sampled and acquired data to the measurement and control subsystem for data processing to obtain electrical property information of the underground media in the target detection region; and the measurement and control subsystem is configured to send a control instruction to the transmitting subsystem and the receiving subsystem according to a sampling result and at least one set detection parameter, and monitor a working status of the detection system, such that during a detection process, the measurement and control subsystem, by adjusting the first current pulse and the second current pulse in real time, enable the bucking electromagnetic field to offset a primary electromagnetic field signal entrained in the secondary electromagnetic field response, realizing adaptive compensation.

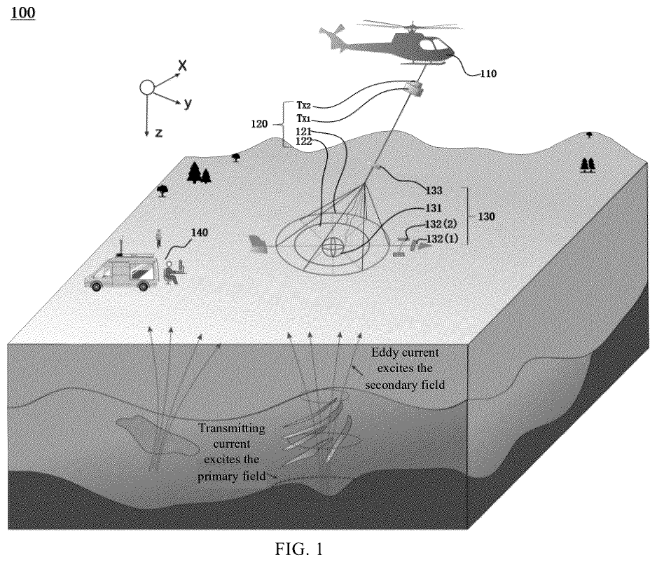

FIG. 1 schematically shows a diagram of a multi-parameter MIMO aeroborne time-frequency electromagnetic detection system according to an embodiment of the present disclosure.

As shown in FIG. 1, an embodiment 100 includes a flight platform 110, a transmitting subsystem 120, a receiving subsystem 130, and a measurement and control subsystem 140. The transmitting subsystem 120 includes a first current transmitter Tx1, a second current transmitter Tx2, a transmitting coil 121, and a bucking coil 122.

According to embodiments of the present disclosure, the flight platform 110 may be a helicopter, a fixed-wing aircraft, a multi-rotor aircraft, an unmanned aerial vehicle, or the like. Preferably, the flight platform 110 is a helicopter, and the flight of the flight platform 110 is controlled by flight personnel. The specific structure and performance parameters may be set according to actual needs, which are not limited herein. The flight parameters of the flight platform include flight altitude, flight speed, and flight route. Before conducting aeroborne detection, each device in the system is assembled, debugged, and self-inspected to complete the flight safety test of the flight platform, ensuring the flight safety of the multi-parameter MIMO aeroborne time-frequency electromagnetic detection system of the flight platform during working.

According to embodiments of the present disclosure, the transmitting subsystem 120 and the receiving subsystem 130 may be hoisted under the flight platform 110 through a pod support device. The pod support device includes a signal and rope composite cable, and the signal and rope composite cable is used to connect the first current transmitter, the second current transmitter, and the transmitting coil, as well as the first current transmitter, the second current transmitter, and the bucking coil. The pod support device further includes a coil support frame for installing and fixing the multi-turn transmitting coil and bucking coil, and maintaining a certain attitude during flight, so as to provide guarantee for subsequent acquisition of stable data.

According to embodiments of the present disclosure, the transmitting coil 121 and the bucking coil 122 are each formed by winding a plurality of turns of copper wire, and are bundled together in a circular tube made of glass fiber material, so as to maintain the shape of the coil and ensure the safety of power supply.

According to embodiments of the present disclosure, the measurement and control subsystem 140 may be arranged on the ground, in the flight platform 110, or on other airborne platforms.

According to embodiments of the present disclosure, the first current transmitter and the second current transmitter are directly powered by the generator of the flight platform. The first current transmitter Tx1 is used to provide a first current pulse composed of a continuous current waveform for the transmitting coil to realize an excitation of a primary electromagnetic field to the underground medium. The second current transmitter Tx2 is used to provide an adaptive compensation current for the bucking coil to realize an excitation of a bucking electromagnetic field. The directions of the currents passing through the bucking coil and the transmitting coil are opposite. The primary electromagnetic field acts on underground media at different depths of the target detection region to generate a secondary electromagnetic field response. The bucking electromagnetic field may offset the primary electromagnetic field signal entrained in the secondary electromagnetic field response, realizing adaptive compensation.

According to embodiments of the present disclosure, the primary electromagnetic field may cause induced eddy currents in the underground medium structure. The electric field and magnetic field signals of the secondary electromagnetic field response generated by the induced eddy currents may be received and acquired by the receiving subsystem through multiple channels, and transmitted to the measurement and control subsystem for processing to obtain the electrical property information of the underground medium in the target detection region.

According to embodiments of the present disclosure, the measurement and control subsystem includes a control unit and a monitoring unit. The control unit is used to send work instructions such as start, continue, and stop to the detection system. The monitoring unit is used to monitor the status, electric field data, magnetic field data, position, altitude, and other information of the detection system in real time. The measurement and control subsystem, by adjusting the first current pulse and the second current pulse in real time, enables the bucking electromagnetic field to offset the primary electromagnetic field signal entrained in the secondary electromagnetic field response, obtain a pure secondary electromagnetic field, and reduce the electromagnetic interference of the transmitting subsystem to the receiving subsystem, realizing adaptive compensation.

According to embodiments of the present disclosure, the above-mentioned detection system further includes: a positioning subsystem for real-time positioning of the flight platform to obtain the latitude and longitude information of the flight platform; and a radar altimeter for measuring the flight altitude of the flight platform.

According to embodiments of the present disclosure, the transmitting subsystem injects a first current pulse into the transmitting coil through the first current transmitter to realize an excitation of a primary electromagnetic field, and injects a second current pulse into the bucking coil through the second current transmitter to realize an excitation of a bucking electromagnetic field, and the primary electromagnetic field acts on underground media at different depths of a target detection region to generate a secondary electromagnetic field response; the receiving subsystem samples the first current pulse and the second current pulse and acquires the secondary electromagnetic field response, so as to transmit the sampled and acquired data to the measurement and control subsystem for data processing to obtain electrical property information of the underground media in the target detection region; and the measurement and control subsystem sends a control instruction to the transmitting subsystem and the receiving subsystem according to a sampling result and at least one set detection parameter, and monitor a working status of the detection system, such that during a detection process, the measurement and control subsystem, by adjusting the first current pulse and the second current pulse in real time, enable the bucking electromagnetic field to offset a primary electromagnetic field signal entrained in the secondary electromagnetic field response, realizing adaptive compensation. The secondary electromagnetic field response is generated after the primary electromagnetic field acts on underground media at different depths of the target detection region, such that multi-component electromagnetic field data may be simultaneously acquired, and different depths of the target detection region are considered. At the same time, the measurement and control subsystem sends a control instruction to the transmitting subsystem and the receiving subsystem to adjust the first current pulse and the second current pulse in real time, such that the bucking electromagnetic field may offset the primary electromagnetic field signal entrained in the secondary electromagnetic field response, reducing primary field electromagnetic interference and obtaining relatively pure multi-component magnetic field data. This avoids the primary field compensation method in the related art where the transmitting coil and the bucking coil are directly connected in series, and realizes adaptive compensation, thereby making the electrical property information of the underground media in the target detection region obtained through analysis more accurate. Therefore, the technical problems in the related art, such as the existence of a shallow blind zone in electromagnetic detection of the target detection region and single electromagnetic response parameter, are effectively solved.

According to embodiments of the present disclosure, as shown in FIG. 1, the receiving subsystem 130 includes a magnetic field sensor 131, electric field sensors 132(1) and 132(2), and an electromagnetic data receiver 133. The secondary electromagnetic field response data includes a magnetic field signal and an electric field signal. The magnetic field sensor is configured to receive a three-component magnetic field signal, and the electric field sensor is configured to receive a horizontal-component electric field signal.

According to embodiments of the present disclosure, the magnetic field sensor is configured to receive magnetic field signals of three components, each component corresponding to a different spatial direction, enabling the receiving subsystem to fully acquire magnetic field data. The electric field sensor may adopt a capacitive design to realize the measurement of multi-component electric field data of an electrical source transient detection system in the air. Therefore, the flight platform may obtain multi-component electric field data and magnetic field data simultaneously with only one airborne operation.

According to embodiments of the present disclosure, the electric field sensor is a horizontal-component capacitive electric field sensor, including: an x-component electric field sensor for measuring an x-component electric field signal parallel to a survey line direction of the detection system; and a y-component electric field sensor for measuring a y-component electric field signal perpendicular to the survey line direction of the detection system.

According to embodiments of the present disclosure, the x-component electric field sensor and the y-component electric field sensor have the same performance parameters, and are connected to the outside of the support structure of the transmitting coil through a connecting frame. The x-component electric field sensor and the y-component electric field sensor may be located 1.5 m to 2 m outside the edge of the transmitting coil.

According to embodiments of the present disclosure, the horizontal-component capacitive x-component electric field sensor and γ-component electric field sensor may respectively measure the x-component electric field signal parallel to the survey line direction of the detection system and the y-component electric field signal perpendicular to the survey line direction of the detection system. The x-component electric field sensor and the y-component electric field sensor may be the capacitive electric field sensor, and may conveniently measure the x-component and γ-component electric field signals in the air without grounding due to the adoption of a non-contact measurement principle.

According to embodiments of the present disclosure, the magnetic field sensor is a three-component coil magnetic field sensor, including: an x-component magnetic field sensor configured in a circular shape, with a normal direction of a circular plane pointing to an x-direction in a geographic Cartesian coordinate system, for measuring an x-component magnetic field in the magnetic field signal; a y-component magnetic field sensor configured in a circular shape, with a normal direction of a circular plane pointing to a y-direction in the geographic Cartesian coordinate system, for measuring a y-component magnetic field in the magnetic field signal; and a z-component magnetic field sensor configured in a circular shape, with a normal direction of a circular plane pointing to a z-direction in the geographic Cartesian coordinate system, for measuring a z-component magnetic field in the magnetic field signal, where the x-component magnetic field sensor, the y-component magnetic field sensor, and the z-component magnetic field sensor are nested and fixedly connected to each other through a connecting device and then placed in a spherical protective cover.

According to embodiments of the present disclosure, the transmitting coil, the bucking coil, and the z-component magnetic field sensor are coplanar on the horizontal plane. The x-component magnetic field sensor and the y-component magnetic field sensor are orthogonal to the horizontal plane. The x-component magnetic field sensor and the y-component electric field sensor are in the same horizontal plane as the transmitting coil and the bucking coil. The x-component magnetic field sensor, the y-component magnetic field sensor, and the z-component magnetic field sensor are orthogonal to each other, nested and fixedly connected to each other through a connecting device, and then placed in a spherical protective cover.

According to embodiments of the present disclosure, the circular magnetic field sensor may uniformly capture changes in the magnetic field. Moreover, the x-component magnetic field sensor, the y-component magnetic field sensor, and the z-component magnetic field sensor are nested and fixedly connected to each other through a connecting device and then placed in a spherical protective cover, which helps to avoid interference from the external environment on the magnetic field sensor. In addition, the flight platform may realize the measurement of three-component magnetic field signals with only a single flight, solving the technical problem in the related art that it is difficult to realize real-time measurement of multi-component magnetic field signals.

According to embodiments of the present disclosure, by changing at least one set parameter of the first current pulse and/or the second current pulse, the transmitting coil excites a primary electromagnetic field suitable for deep detection and shallow detection according to a set timing sequence, and the bucking coil synchronously excites a bucking magnetic field to offset primary electromagnetic field interference acting on the receiving subsystem. The at least one set parameter includes a frequency, an amplitude, a width, a waveform, a flow direction, and a timing sequence of the current pulse.

According to embodiments of the present disclosure, the first current transmitter and the second current transmitter may generate first current pulses and second current pulses with different set parameters according to actual needs, and inject the first current pulses and the second current pulses into the transmitting coil and the bucking coil respectively to form different excitation electromagnetic fields.

According to embodiments of the present disclosure, the first current pulse may enable the airborne transmitting coil to generate wideband primary electromagnetic fields covering various frequency bands, and simultaneously excite shallow and deep field sources of the underground medium to generate secondary electromagnetic fields with strong signals.

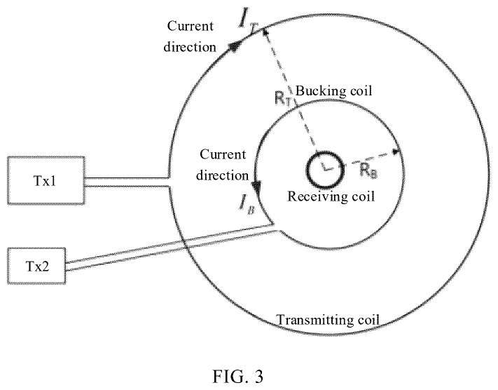

FIG. 3 schematically shows a principle diagram of adaptive compensation performed by a multi-parameter MIMO aeroborne time-frequency electromagnetic detection system according to an embodiment of the present disclosure.

According to embodiments of the present disclosure, the measurement and control subsystem real-time detects the data of the receiving subsystem in combination with the turn ratio relationship between the transmitting coil and the bucking coil, and adaptively adjusts the amplitude of the current pulses passing through the transmitting coil and/or the bucking coil, such that the bucking coil excites a bucking electromagnetic field to offset the primary electromagnetic field interference acting on the magnetic field sensor. The directions of currents passing through the bucking coil and the transmitting coil are opposite, such that the primary electromagnetic field interference in the receiving coil of the z-component magnetic field sensor tends to zero, and pure secondary magnetic field response data is obtained.

According to embodiments of the present disclosure, in the ideal case that the magnitude relationship between the amplitude IT of the first current pulse injected into the transmitting coil and the amplitude IB of the second current pulse injected into the bucking coil satisfies the following Formula (1), the bucking magnetic field synchronously excited by the bucking coil may offset the primary electromagnetic field interference acting on the receiving subsystem.

$$\frac{{N}_{T} {I}_{T}}{{R}_{T}} = \frac{{N}_{B} {I}_{B}}{{R}_{B}} \qquad ( 1 )$$

N_{T} denotes the number of turns of the transmitting coil, R_{T} denotes the radius of the transmitting coil, NB denotes the number of turns of the bucking coil, and RB denotes the radius of the bucking coil.

According to embodiments of the present disclosure, the measurement and control subsystem realizes primary electromagnetic field excitation for deep detection and shallow detection by adjusting the frequency, amplitude, width, waveform, flow direction, and timing sequence of the first current pulse and/or the second current pulse, ensuring that the bucking magnetic field is accurately matched with the electromagnetic field generated by the transmitting coil in time and space, and enabling the bucking coil to synchronously excite the bucking magnetic field to offset the primary electromagnetic field interference acting on the receiving subsystem, thereby achieving efficient and accurate detection of the target detection region.

According to embodiments of the present disclosure, both the transmitting coil and the bucking coil are configured in an annular shape and arranged concentrically on the same plane, the bucking coil is smaller than the transmitting coil, and the magnetic field sensor is disposed at the central position of the bucking coil. By acquiring the primary electromagnetic field interference at the magnetic field sensor in real time, the second current pulse is adjusted such that the bucking coil excites a bucking electromagnetic field to offset the primary electromagnetic field interference.

According to embodiments of the present disclosure, the transmitting coil and the bucking coil may be a circular ring shape, or a regular polygonal ring shape, for example a regular 20-sided polygonal ring shape.

According to embodiments of the present disclosure, the bucking coil is smaller than the transmitting coil to ensure that the maximum compensation effect is produced at the position of the magnetic field sensor.

According to embodiments of the present disclosure, the magnetic field sensor is disposed at the central position of the bucking coil, which helps to improve the accuracy and signal-to-noise ratio of magnetic field data.

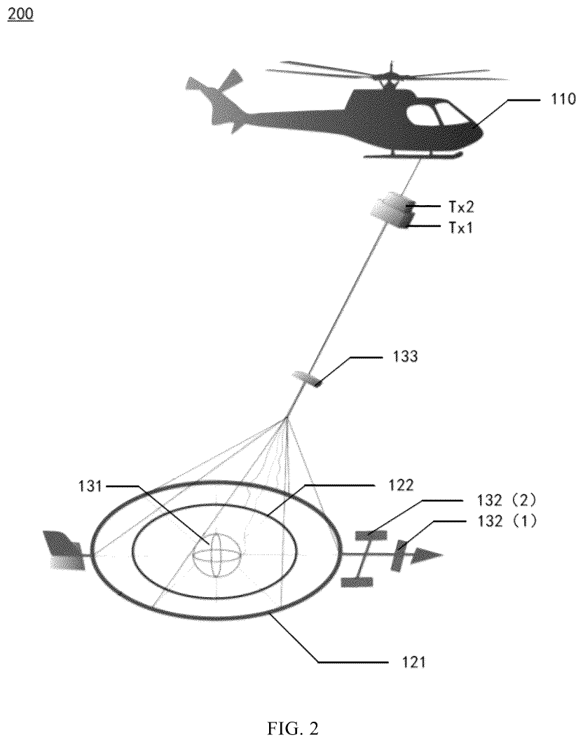

In order to better understand the relative positions of the flight platform, the transmitting subsystem, and the receiving subsystem of the multi-parameter MIMO aeroborne time-frequency electromagnetic detection system according to embodiments of the present disclosure, the relative positions of the flight platform, the transmitting subsystem, and the receiving subsystem will be described below with reference to FIG. 2.

FIG. 2 schematically shows a structural diagram of a flight platform, a transmitting subsystem, and a receiving subsystem according to an embodiment of the present disclosure.

As shown in FIG. 2, an embodiment 200 includes a flight platform 110, a transmitting subsystem, and a receiving subsystem. The transmitting subsystem includes a first current transmitter Tx1, a second current transmitter Tx2, a transmitting coil 121, and a bucking coil 122. The receiving subsystem 130 includes a magnetic field sensor 131, an x-component electric field sensor 132(1), a y-component electric field sensor 132(2), and an electromagnetic data receiver 133.

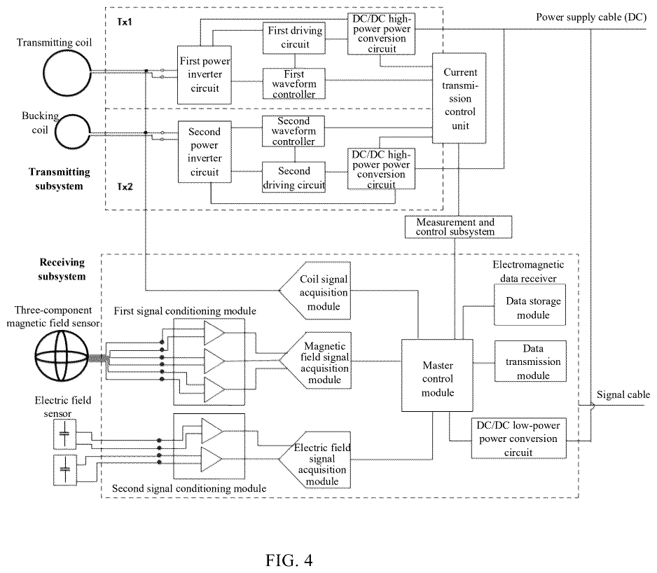

FIG. 4 schematically shows a circuit principle diagram of a multi-parameter MIMO aeroborne time-frequency electromagnetic detection system according to an embodiment of the present disclosure.

According to embodiments of the present disclosure, as shown in FIG. 4, the first current transmitter Tx1 includes a first driving circuit, a first waveform controller, a first power inverter circuit, a first constant-voltage double-clamp circuit, and a first current detection circuit; the first power inverter circuit unit is configured to generate a first current pulse with at least one set parameter under an action of the first driving circuit, the first waveform controller, and the first constant-voltage double-clamp circuit unit, and inject the first current pulse into the transmitting coil. The second current transmitter Tx2 includes a second driving circuit, a second waveform controller, a second power inverter circuit, a second constant-voltage double-clamp circuit, and a second current detection circuit, where the second power inverter circuit unit is configured to generate a second current pulse with at least one set parameter under an action of the second driving circuit, the second waveform controller, and the second constant-voltage double-clamp circuit unit, and inject the second current pulse into the bucking coil. The first current detection circuit and the second current detection circuit are used to respectively detect parameters of a first current pulse signal and a second current pulse signal in the transmitting coil and the bucking coil in real time. A current transmission control unit is configured to control the first current transmitter and the second current transmitter to operate under an action of a control instruction issued by the measurement and control subsystem.

According to embodiments of the present disclosure, the first current transmitter further includes a DC/DC high-power power conversion circuit for supplying power to the first driving circuit, the first waveform controller, and the first power inverter circuit, and converting the DC supply voltage.

According to embodiments of the present disclosure, the second current transmitter further includes a DC/DC high-power power conversion circuit for supplying power to the second driving circuit, the second waveform controller, and the second power inverter circuit, and converting the DC supply voltage.

According to embodiments of the present disclosure, the first constant-voltage double-clamp circuit unit is used to clamp both a rising edge and a falling edge of the first current pulse emitted by the first current transmitter, so as to improve the linearity and slope of the current edge and reduce the turn-off time.

According to embodiments of the present disclosure, the second constant-voltage double-clamp circuit unit is used to clamp both a rising edge and a falling edge of the second current pulse emitted by the second current transmitter, so as to improve the linearity and slope of the current edge and reduce the turn-off time.

According to embodiments of the present disclosure, the first current detection circuit and the second current detection circuit may be high-precision current detection circuits for detecting the waveforms of the generated first current pulse and second current pulse.

According to embodiments of the present disclosure, the electromagnetic data receiver includes a signal conditioning module, a signal acquisition module, a master control module, and a data transmission module. The signal conditioning module includes a first signal conditioning module for filtering and amplifying the received magnetic field signal, and a second signal conditioning module for filtering and amplifying the received electric field signal. The signal acquisition module is configured to perform real-time data sampling on the transmitting coil, the bucking coil, and the signal conditioning module, respectively. The master control module is configured to receive a real-time data sampling result and transmit the real-time data sampling result to the measurement and control subsystem, such that the measurement and control subsystem adjusts the first current pulse and the second current pulse in real time according to the real-time data sampling result.

According to embodiments of the present disclosure, the electromagnetic data receiver further includes a data storage module for real-time storing a sampling result, which may effectively prevent data loss. The master control module may maintain the synchronization of data transmission and reception between various modules based on the Beidou Navigation System, GPS (Global Positioning System), or optical fiber transmission, and realize the upload, download, and deletion of the control instruction of the measurement and control subsystem.

According to embodiments of the present disclosure, the signal acquisition module may be an analog-to-digital converter (ADC) circuit, which may convert the analog signals of the first signal conditioning module and the second signal conditioning module into digital signals.

As shown in FIG. 4, the receiving subsystem is designed to acquire the electric field signal and the magnetic field signal through the three-component magnetic field sensor and the horizontal-component capacitive electric field sensor. The first signal conditioning module performs gain preprocessing on the received magnetic field signal, the second signal conditioning module performs gain preprocessing on the received electric field signal, and the filtering and amplification of electromagnetic signals by the first signal conditioning module and the second signal conditioning module are performed synchronously. The coil signal acquisition module, the magnetic field signal acquisition module, and the electric field signal acquisition module are respectively used for real-time synchronous sampling of the transmitting coil and the bucking coil, the first signal conditioning module, and the second signal conditioning module.

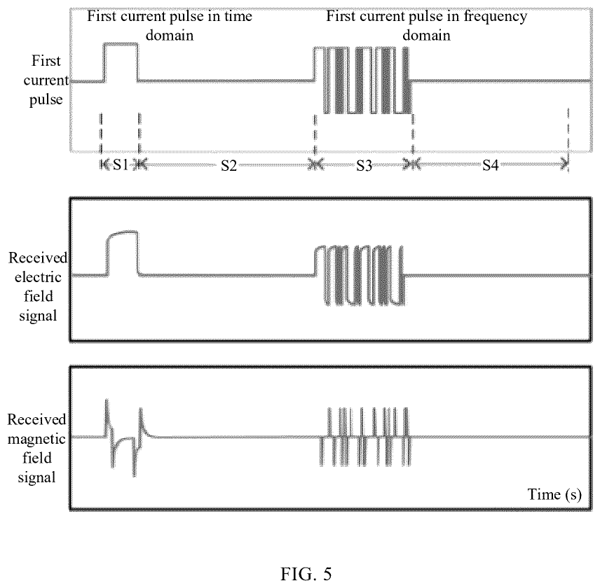

FIG. 5 schematically shows a waveform diagram of a received signal and a transmitted signal of a multi-parameter MIMO aeroborne time-frequency electromagnetic detection system according to an embodiment of the present disclosure.

As shown in FIG. 5, the horizontal axis represents time, which includes a set timing sequence, and the transmitting subsystem transmits the first current pulse and the second current pulse according to the set timing sequence.

In the state S1, the first current transmitter generates a time-domain bipolar-square-wave first current pulse of 1.25 Hz to 25 Hz and inputs the time-domain bipolar-square-wave first current pulse into the transmitting coil, and the amplitude of the time-domain bipolar-square-wave first current pulse may be in a range of 200 A to 300 A. The receiving subsystem synchronously acquires multi-parameter and multi-channel three-component magnetic field signals and horizontal electric field signals for deep detection.

In the state S3, the first current transmitter generates a frequency-domain multi-frequency first current pulse of 1 Hz to 20 kHz and inputs the frequency-domain multi-frequency first current pulse into the transmitting coil, and the amplitude of the frequency-domain multi-frequency first current pulse may be in a range of 10 A to 50 A. The receiving subsystem synchronously acquires multi-parameter and multi-channel three-component magnetic field signals and horizontal electric field signals for shallow detection.

In the states S2 and S4, the transmitting coil does not work. The purpose of setting these states is to wait for the end of the excitation of the first current pulse and the second current pulse.

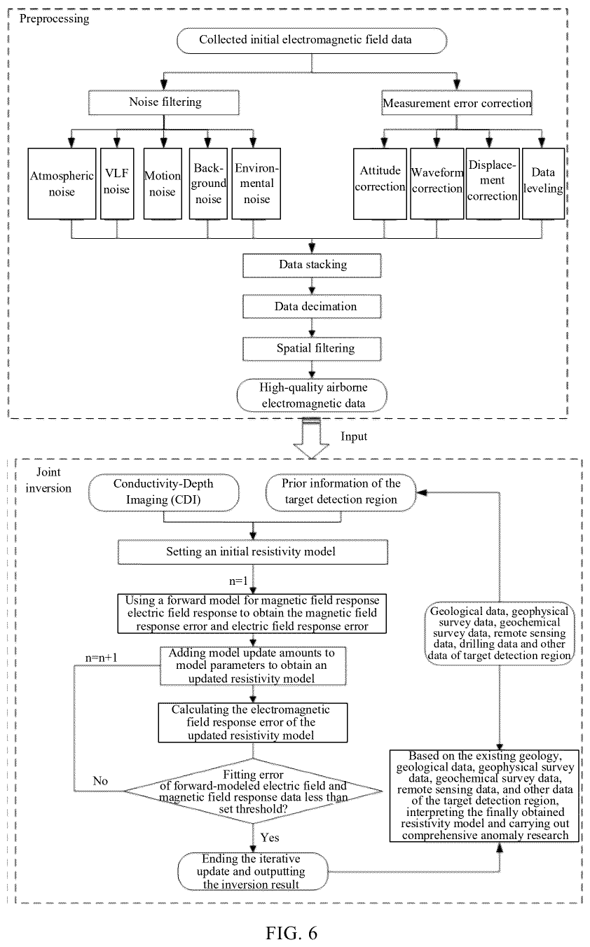

FIG. 6 schematically shows a diagram of obtaining electrical property information of underground media in a target detection region through joint inversion according to an embodiment of the present disclosure.

According to embodiments of the present disclosure, the electrical property information of the underground media in the target detection region is obtained by performing joint inversion of electric field and magnetic field data on the secondary electromagnetic field response data, and the joint inversion includes: setting an initial resistivity model, where the resistivity model is a resistivity-depth imaging resistivity model; respectively calculating an error between a magnetic field response of the initial resistivity model and an observed magnetic field response and an error between an electric field response of the initial resistivity model and an observed electric field response by using a forward model for the magnetic field response and the electric field response, so as to obtain a magnetic field response error and an electric field response error; constructing a Jacobian matrix for inversion of magnetic field data and inversion of electric field data by using the forward model and the resistivity model, and respectively calculating a model update amount for the inversion of magnetic field data and a model update amount for the inversion of electric field data by using the magnetic field response error and the electric field response error; adding the model update amounts to model parameters to obtain an updated resistivity model; and performing iterative updating until a fitting error of the forward-modeled electric and magnetic field response data of the updated resistivity model is less than a set threshold.

According to embodiments of the present disclosure, before the joint inversion, it is necessary to perform preprocessing operations on the secondary electromagnetic field response data. The preprocessing operations include noise filtering, error correction, data stacking, data decimation, and spatial filtering, which are specifically as follows:
(1) Noise filtering: denoising processing is carried out on the electromagnetic field data acquired by the receiving subsystem. Related technologies such as alpha-trim filtering, polynomial fitting, mean filtering, and altitude correction may be used to suppress and remove atmospheric noise, motion noise, VLF (Very Low Frequency) noise, background noise, power frequency interference, human-made environment noise, etc., existing in the electromagnetic field data.
(2) Error correction: for problems such as transmitting waveform stability, attitude effect, and inter-line leveling error existing in the electromagnetic field data in the detection system, the processing using related correction technologies such as transmitting waveform correction, attitude correction, and interactive dynamic data leveling respectively is performed.
(3) Data stacking: after error correction, stacking processing is performed on multi-component electromagnetic field data to eliminate redundant information, reduce data volume, and eliminate random noise, which is conducive to improving the signal-to-noise ratio of the data.
(4) Data decimation: the multi-component electromagnetic field data in the time domain is processed by decimating at approximately logarithmic time intervals, where data decimation is not required for electromagnetic field data in the frequency domain.
(5) Spatial filtering: low-pass filtering or trapezoidal waveform is used to perform spatial filtering processing on the profile of electromagnetic field data, further improving the signal-to-noise ratio of the data to obtain high-quality airborne electromagnetic data that may be used for fine inversion and interpretation.

According to embodiments of the present disclosure, resistivity-depth imaging processing is performed on the airborne electromagnetic data to obtain the resistivity-depth imaging result, and a regularized initial resistivity model is constructed based on the resistivity-depth imaging result and existing prior information such as geological data, geophysical survey data, geochemical survey data, remote sensing data, and drilling data in the target detection region, so as to avoid the impact of unconstrained initial model construction on the inversion result.

According to embodiments of the present disclosure, it is determined whether the fitting error of the forward-modeled electric field and magnetic field response data of the updated resistivity model is less than a set threshold. If the fitting error of the forward-modeled electric field and magnetic field response data of the resistivity model is less than the set threshold, the inversion calculation is ended. If the fitting error of the forward-modeled electric field and magnetic field response data of the resistivity model is not less than the set threshold, the iteration for the resistivity model is continued, the model update amount is recalculated, the resistivity model is updated, and the determination operation is repeated until the fitting error of the forward-modeled electric field and magnetic field response data of the updated resistivity model is less than the set threshold, then the final resistivity model is obtained, the joint inversion is ended, and the electrical property information of the underground media in the target detection region is obtained.

In order to better understand the above-mentioned joint inversion process, the preprocessing before the joint inversion process and the process of obtaining the electrical property information of the underground media in the target detection region according to the inversion result will be described below with reference to FIG. 6.

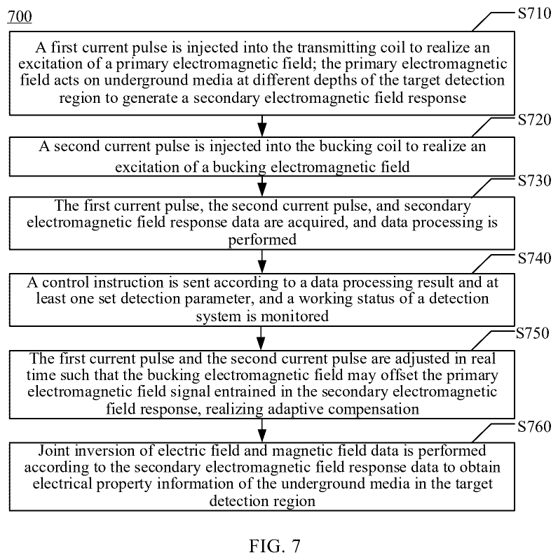

FIG. 7 schematically shows a flowchart of a multi-parameter MIMO aeroborne time-frequency electromagnetic detection method according to an embodiment of the present disclosure.

As shown in FIG. 7, a method 700 includes operation S710 to operation S760.

In operation S710, a first current pulse is injected into the transmitting coil to realize an excitation of a primary electromagnetic field; the primary electromagnetic field acts on underground media at different depths of the target detection region to generate a secondary electromagnetic field response.

In operation S720, a second current pulse is injected into the bucking coil to realize an excitation of a bucking electromagnetic field.

In operation S730, the first current pulse, the second current pulse, and secondary electromagnetic field response data are acquired, and data processing is performed.

In operation S740, a control instruction is sent according to a data processing result and at least one set detection parameter, and a working status of a detection system is monitored.

In operation S750, the first current pulse and the second current pulse are adjusted in real time such that the bucking electromagnetic field may offset the primary electromagnetic field signal entrained in the secondary electromagnetic field response, realizing adaptive compensation.

In operation S760, joint inversion of electric field and magnetic field data is performed according to the secondary electromagnetic field response data to obtain electrical property information of the underground media in the target detection region.

It should be noted that the multi-parameter MIMO aeroborne time-frequency electromagnetic detection method part in embodiments of the present disclosure corresponds to the multi-parameter MIMO aeroborne time-frequency electromagnetic detection system part in embodiments of the present disclosure. For the description of the detection method part, refer to the detection system part, which will not be described in detail here.

According to embodiments of the present disclosure, primary electromagnetic field excitation is realized by injecting a first current pulse into the transmitting coil, and an excitation of a bucking electromagnetic field is realized by injecting a second current pulse into the bucking coil. The primary electromagnetic field acts on underground media at different depths of a target detection region to generate a secondary electromagnetic field response. The first current pulse and the second current pulse are sampled, and the secondary electromagnetic field response is acquired for data processing to obtain electrical property information of the underground media in the target detection region. A control instruction is sent according to a sampling result and at least one set detection parameter, and a working status of the detection system is monitored, such that during a detection process, the measurement and control subsystem, by adjusting the first current pulse and the second current pulse in real time, enable the bucking electromagnetic field to offset a primary electromagnetic field signal entrained in the secondary electromagnetic field response, realizing adaptive compensation. The secondary electromagnetic field response is generated after the primary electromagnetic field acts on underground media at different depths of the target detection region, such that multi-component electromagnetic field data may be simultaneously acquired, and different depths of the target detection region are considered. At the same time, the measurement and control subsystem sends a control instruction to the transmitting subsystem and the receiving subsystem to adjust the first current pulse and the second current pulse in real time, such that the bucking electromagnetic field may offset the primary electromagnetic field signal entrained in the secondary electromagnetic field response, reducing primary field electromagnetic interference and obtaining relatively pure multi-component magnetic field data. This avoids the primary field compensation method in the related art where the transmitting coil and the bucking coil are directly connected in series, and realizes adaptive compensation, thereby making the electrical property information of the underground media in the target detection region obtained through analysis more accurate. Therefore, the technical problems in the related art, such as the existence of a shallow blind zone in electromagnetic detection of the target detection region and single electromagnetic response parameter, are effectively solved.

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of code, which contains one or more executable instructions for implementing the specified logical function. It should also be noted that, in some alternative implementations, the functions noted in the blocks may occur out of the order noted in the drawings. For example, two blocks shown in succession may, in fact, be executed substantially concurrently, or the two blocks may sometimes be executed in a reverse order, depending upon the functionality involved. It should also be noted that each block of the block diagrams or flowcharts, and combinations of the blocks in the block diagrams or flowcharts, may be implemented by using a special purpose hardware-based system that performs the specified functions or operations, or may be implemented using a combination of a special purpose hardware and computer instructions. Those skilled in the art will appreciate that features recited in the various embodiments of the present disclosure may be combined and/or incorporated in a variety of ways, even if such combinations or incorporations are not clearly recited in the present disclosure. In particular, the features recited in the various embodiments of the present disclosure may be combined and/or incorporated in a variety of ways without departing from the spirit and teachings of the present disclosure, and all such combinations and/or incorporations fall within the scope of the present disclosure.

Embodiments of the present disclosure have been described above. However, these embodiments are for illustrative purposes only, and are not intended to limit the scope of the present disclosure. Although the various embodiments are described above separately, this does not mean that the measures in the various embodiments may not be advantageously used in combination. Without departing from the scope of the present disclosure, those skilled in the art may make various substitutions and modifications, and these substitutions and modifications should all fall within the scope of the present disclosure.

1. A multi-parameter MIMO aeroborne time-frequency electromagnetic detection system, comprising a flight platform, a transmitting subsystem, a receiving subsystem, and a measurement and control subsystem, wherein the transmitting subsystem and the receiving subsystem are hoisted under the flight platform,
the transmitting subsystem comprises a first current transmitter, a second current transmitter, a transmitting coil, and a bucking coil, the transmitting subsystem is configured to inject a first current pulse into the transmitting coil through the first current transmitter to realize an excitation of a primary electromagnetic field, and to inject a second current pulse into the bucking coil through the second current transmitter to realize an excitation of a bucking electromagnetic field, and the primary electromagnetic field acts on underground media at different depths of a target detection region to generate a secondary electromagnetic field response;
the receiving subsystem is configured to sample the first current pulse and the second current pulse and acquire the secondary electromagnetic field response, so as to transmit the sampled and acquired data to the measurement and control subsystem for data processing to obtain electrical property information of the underground media in the target detection region; and
the measurement and control subsystem is configured to send a control instruction to the transmitting subsystem and the receiving subsystem according to a sampling result and at least one set detection parameter, and monitor a working status of the detection system, such that during a detection process, the measurement and control subsystem, by adjusting the first current pulse and the second current pulse in real time, enable the bucking electromagnetic field to offset a primary electromagnetic field signal entrained in the secondary electromagnetic field response, realizing adaptive compensation,
wherein by changing at least one set parameter of the first current pulse and the second current pulse, the transmitting coil excites the primary electromagnetic field suitable for deep detection and shallow detection according to a set timing sequence, and the bucking coil synchronously excites a bucking magnetic field to offset primary electromagnetic field interference acting on the receiving subsystem; and the at least one set parameter comprises a frequency, an amplitude, a width, a waveform, a flow direction, and a timing sequence of each current pulse,
in a state S1, the first current transmitter generates a time-domain bipolar-square-wave first current pulse of 1.25 Hz to 25 Hz and inputs the time-domain bipolar-square-wave first current pulse into the transmitting coil, wherein an amplitude of the time-domain bipolar-square-wave first current pulse is in a range of 200 A to 300 A, and the receiving subsystem synchronously acquires multi-parameter and multi-channel three-component magnetic field signals and horizontal electric field signals for the deep detection; in a state S3, the first current transmitter generates a frequency-domain multi-frequency first current pulse of 1 Hz to 20 kHz and inputs the frequency-domain multi-frequency first current pulse into the transmitting coil, wherein an amplitude of the frequency-domain multi-frequency first current pulse is in a range of 10 A to 50 A, and the receiving subsystem synchronously acquires multi-parameter and multi-channel three-component magnetic field signals and horizontal electric field signals for the shallow detection; and in states S2 and S4, the transmitting coil does not work to wait for an end of excitation of the first current pulse and the second current pulse.

2. (canceled)

3. The detection system according to claim 1, wherein the receiving subsystem comprises a magnetic field sensor, an electric field sensor, and an electromagnetic data receiver, and the secondary electromagnetic field response comprises a magnetic field signal and an electric field signal, wherein the magnetic field sensor is configured to receive a three-component magnetic field signal, and the electric field sensor is configured to receive a horizontal-component electric field signal.

4. The detection system according to claim 3, wherein both the transmitting coil and the bucking coil are configured in an annular shape and arranged concentrically on a same plane, the bucking coil is smaller than the transmitting coil, and the magnetic field sensor is disposed at a central position of the bucking coil; by acquiring the primary electromagnetic field interference at the magnetic field sensor in real time, the second current pulse is adjusted such that the bucking coil excites the bucking electromagnetic field to offset the primary electromagnetic field interference.

5. The detection system according to claim 3, wherein the electric field sensor is a horizontal-component capacitive electric field sensor, comprising:
an x-component electric field sensor configured for measuring an x-component electric field signal parallel to a survey line direction of the detection system; and
a y-component electric field sensor configured for measuring a y-component electric field signal perpendicular to the survey line direction of the detection system.

6. The detection system according to claim 3, wherein the magnetic field sensor is a three-component coil magnetic field sensor, comprising:
an x-component magnetic field sensor configured in a circular shape, with a normal direction of a circular plane pointing to an x-direction in a geographic Cartesian coordinate system, for measuring an x-component magnetic field in the magnetic field signal;
a y-component magnetic field sensor configured in a circular shape, with a normal direction of a circular plane pointing to a y-direction in the geographic Cartesian coordinate system, for measuring a y-component magnetic field in the magnetic field signal; and
a z-component magnetic field sensor configured in a circular shape, with a normal direction of a circular plane pointing to a z-direction in the geographic Cartesian coordinate system, for measuring a z-component magnetic field in the magnetic field signal,
wherein the x-component magnetic field sensor, the y-component magnetic field sensor, and the z-component magnetic field sensor are nested and fixedly connected to each other through a connecting device and then placed in a spherical protective cover.

7. The detection system according to claim 4, wherein the electromagnetic data receiver comprises a signal conditioning module, a signal acquisition module, a master control module, and a data transmission module, wherein
the signal conditioning module comprises a first signal conditioning module for filtering and amplifying the received magnetic field signal, and a second signal conditioning module for filtering and amplifying the received electric field signal;
the signal acquisition module is configured to perform real-time data sampling on the transmitting coil, the bucking coil, and the signal conditioning module, respectively; and
the master control module is configured to receive a real-time data sampling result and transmit the real-time data sampling result to the measurement and control subsystem, such that the measurement and control subsystem adjusts the first current pulse and the second current pulse in real time according to the real-time data sampling result.

8. The detection system according to claim 4, wherein
the first current transmitter comprises a first driving circuit, a first waveform controller, a first power inverter circuit, a first constant-voltage double-clamp circuit, and a first current detection circuit; the first power inverter circuit is configured to generate the first current pulse with the at least one set parameter under an action of the first driving circuit, the first waveform controller, and the first constant-voltage double-clamp circuit, and inject the first current pulse into the transmitting coil; and
the second current transmitter comprises a second driving circuit, a second waveform controller, a second power inverter circuit, a second constant-voltage double-clamp circuit, and a second current detection circuit, wherein
the second power inverter circuit is configured to generate the second current pulse with the at least one set parameter under an action of the second driving circuit, the second waveform controller, and the second constant-voltage double-clamp circuit, and inject the second current pulse into the bucking coil;
the first current detection circuit and the second current detection circuit are configured to respectively detect parameters of a first current pulse signal and a second current pulse signal in the transmitting coil and the bucking coil in real time; and
a current transmission control unit is configured to control the first current transmitter and the second current transmitter to operate under an action of the control instruction issued by the measurement and control subsystem.

9. The detection system according to claim 4, wherein the electrical property information of the underground media in the target detection region is obtained by performing joint inversion of electric field and magnetic field data on the secondary electromagnetic field response data, and the joint inversion comprises:
setting an initial resistivity model, wherein the resistivity model is a resistivity-depth imaging resistivity model;
respectively calculating an error between a magnetic field response of the initial resistivity model and an observed magnetic field response and an error between an electric field response of the initial resistivity model and an observed electric field response by using a forward model for the magnetic field response and the electric field response, so as to obtain a magnetic field response error and an electric field response error;
constructing a Jacobian matrix for inversion of magnetic field data and inversion of electric field data by using the forward model and the resistivity model, and respectively calculating a model update amount for the inversion of magnetic field data and a model update amount for the inversion of electric field data by using the magnetic field response error and the electric field response error;
adding the model update amounts to model parameters to obtain an updated resistivity model; and
performing iterative updating until a fitting error of the forward-modeled electric field and magnetic field response data of the updated resistivity model is less than a set threshold.

10. A multi-parameter MIMO aeroborne time-frequency electromagnetic detection method based on the detection system of claim 1, comprising:
injecting a first current pulse into a transmitting coil to realize an excitation of a primary electromagnetic field, wherein the primary electromagnetic field acts on underground media at different depths of a target detection region to generate a secondary electromagnetic field response;
injecting a second current pulse into a bucking coil to realize an excitation of a bucking electromagnetic field;
acquiring the first current pulse, the second current pulse, and secondary electromagnetic field response data, and performing data processing;
sending a control instruction according to a data processing result and at least one set detection parameter, and monitoring a working status of a detection system;
adjusting the first current pulse and the second current pulse in real time to enable the bucking electromagnetic field to offset a primary electromagnetic field signal entrained in the secondary electromagnetic field response, realizing adaptive compensation; and
performing joint inversion of electric field and magnetic field data according to the secondary electromagnetic field response data to obtain electrical property information of the underground media in the target detection region.
